(19) United States
(12) Patent Application Publication
(10) Pub. No.: US 2008/0045256 A1
(43) Pub. Date: Feb. 21, 2008

(54) Eyes-free push-to-talk communication

(75) Inventors: Kuansan Wang, Bellevue, WA (US); Xuedong Huang, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/505,120

(22) Filed: Aug. 16, 2006

(51) Int. Cl. H04B 1/38; H04B 7/00

(52) U.S. Cl. 455/518; 455/90.2

(57) ABSTRACT

A push-to-talk feature on a mobile handset is initiated by speaking a recipient's name as the first part of an initial message. A speech recognition device located in the handset or in a push-to-talk server may recognize the recipient's name, determine the proper addressing for the message, establish a push-to-talk session, and deliver the message to the intended recipient. The session may continue until a session timeout has occurred, until another session is started, or until the user otherwise terminates the session.

### BACKGROUND

Push-to-Talk is a feature that has long been used in radio communications. In Push-to-Talk, a user keys a switch and speaks a message that is transmitted to one or more recipients in a half duplex mode. When the user releases the key, the transmission stops and another user may respond.

Push-to-Talk is becoming a more widespread feature in cellular phones and other telephony systems, including Voice over IP (VoIP). The usefulness and convenience of the feature has been shown to be commercially viable and is increasing in deployment. As the complexity and feature set of a cellular telephone or other handheld mobile device increases, the complexity of the user interface also increases. Such complexity greatly increases the risk of an accident if a user attempts to navigate a user interface while driving or performing other tasks that require the user's visual attention.

### SUMMARY

A push-to-talk feature on a mobile handset is initiated by speaking a recipient's name as the first part of an initial message. A speech recognition device located in the handset or in a push-to-talk server may recognize the recipient's name, determine the proper addressing for the message, establish a push-to-talk session, and deliver the message to the intended recipient. The session may continue until a session timeout has occurred, until another session is started, or until the user otherwise terminates the session.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a pictorial illustration of an embodiment showing a system for push-to-talk communications.

FIG. 2 is a flowchart illustration of an embodiment showing a method for push-to-talk communications.

FIG. 3 is a diagrammatic illustration of an embodiment showing a handset capable of speech recognition.

FIG. 4 is a diagrammatic illustration of an embodiment showing a push-to-talk server with speech recognition capabilities.

### DETAILED DESCRIPTION

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

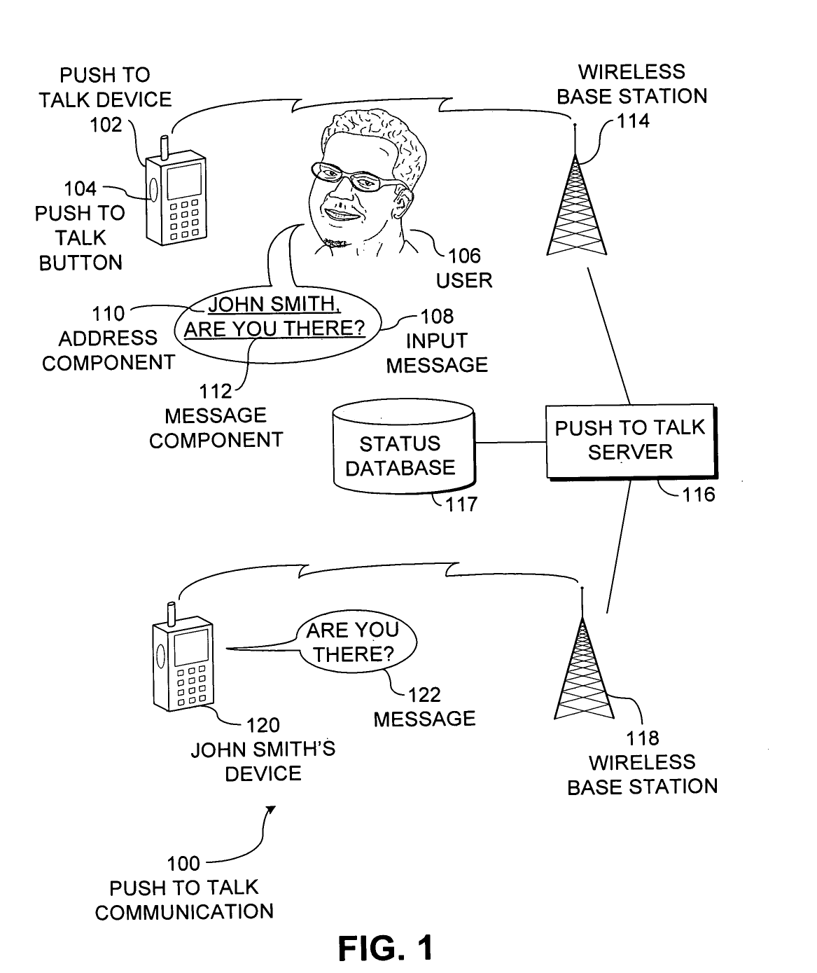

FIG. 1 is a diagram of an embodiment 100 showing a push-to-talk communication. The push-to-talk device 102 has a push-to-talk button that the user 106 may engage and speak a message 108. The message 108 has two components: an address component 110 and a message component 112. The push-to-talk device 102 transmits the message 108 to a wireless base station 114, which routes the message to a push-to-talk server 116.

The address of the intended device may be resolved using speech processing techniques in either the push-to-talk device 102 or the push-to-talk server 116. When the address is resolved, the push-to-talk server 116 may query a status database 117 to determine the online status of the recipient. Also when the message 108 is parsed by the speech processing device, the message component 112 is separated. The message component is transmitted to a wireless base station 118 and then to the recipient's device 120 to be played as message 112.

The embodiment 100 is one method by which a push-to-talk session can be established without requiring the user 106 to divert visual attention to the device 102. In order to establish a new push-to-talk session with another user, the user 106 states the recipient's name followed by the initial push-to-talk message. A speech recognition device, located in either the push-to-talk device 102 or the push-to-talk server 116, is adapted to parse the initial message 108 into two components: the address component 110 and the message component 112.

The address component 110 is used to compare to a database of recipients, which may be located in the device 102 and could be the personal list associated with user 106. In some instances, the user 106 may create audio samples that are associated with members of the recipient list and the address component 110 may be compared with the pre-recorded audio samples in the database to resolve which recipient is the intended one.

In some embodiments, a user's personal recipient list may be input and managed using the user's device 102, but a copy of the recipient list may also be maintained on the push-to-talk server 1116. In such embodiments, a speech recognition system located on the server 116 may perform the message parsing and address resolution.

When an address is determined for the message, the status of the recipient may be obtained through the status database 117. The status database 117 may be a presence management system that keeps track of the online, offline, or busy states of several users. In some embodiments, the status database 117 may keep track of all the subscribers to a particular push-to-talk service, which may be a superset of the personal recipient database maintained by the user 106. If a recipient is not available to receive a message, an audio, text, or multimedia response to the message 108 may be generated and transmitted to the user 106.

The device 102 may be any device capable of push-to-talk services. In a typical application, the device 102 may be a walkie-talkie type radio, push-to-talk over cellular (‘PoC’) handset, a voice over IP (‘VoIP’) telephone device, a cellular phone mounted in an automobile, or any other device capable of push-to-talk. A feature normally found on such a device is a push-to-talk button 104 that is often a prominent button located where a user can easily activate the button while speaking into the device. The present embodiment allows a user to initiate a push-to-talk session by speaking the recipient's name as the first part of the initial message. This may allow a user to set up a push-to-talk session while driving a car or performing another operation where it may be dangerous or difficult to glance at the screen of the device to select a recipient. The push-to-talk session may be between two users in a peer to peer mode, or may be a group broadcast with three or more users.

Many devices have a display that may show several available choices for push-to-talk recipients. In some embodiments, a speech recognition system in the device 102 may select a name from the display based on the speech input to the device and not require the user to scroll up or down and select the user from a list, which may require the user's visual attention. In such an embodiment, the speech recognition routine may act as a substitute for the manual method of selecting from a menu or list.

The embodiment 100 illustrates a push-to-talk scenario using wireless devices 102 and 120. In many cases, the devices 102 and/or 120 may be wired devices such as a desktop telephone, personal computer operating voice over IP, or any other fixed device. Consequently, some embodiments may utilize two wireless base stations as depicted in embodiment 100, while other embodiments may use one or even no wireless base station.

The message component 112 may be parsed from the input message 108 and transmitted as message 122. In some cases, the address component 110 may be a personal ‘handle’ or nickname used to identify a recipient by the user 106, and such a nickname may not be appropriate or desirable for the sender to transmit to the user. In other embodiments, both the address component 110 and message component 112 may be transmitted within the message 122.

In some embodiments, activating a push-to-talk button when no session is currently active may start a default transmission to a particular person in peer to peer mode or to a group in broadcast mode. When such a default configuration is present, a speech recognition algorithm or mechanism may be applied to determine if the first portion of an initial message is an address and therefore intended to initiate a conversation in peer to peer mode as opposed to a default setting which may be a broadcast mode. In some systems, a peer to peer session may require a special command or format to initiate a session of either peer to peer or broadcast mode.

A peer to peer session is one in which push-to-talk messages are exchanged between two devices. This is distinguished from a broadcast mode where several devices receive a push-to-talk message. In some embodiments, a recipient name in the address component 110 may be used to refer to a subgroup or recipients and the message component 112 may be broadcast to that subgroup. In such an embodiment, a broadcast or group session would be initiated rather than a peer to peer session.

The session established between the device 102 and device 120 may continue until terminated. In some cases, a timer may be used to terminate the session after a predetermined amount of inactivity. In other cases, one of the users may press a button, speak a key phrase, or otherwise enter a command that terminates the session.

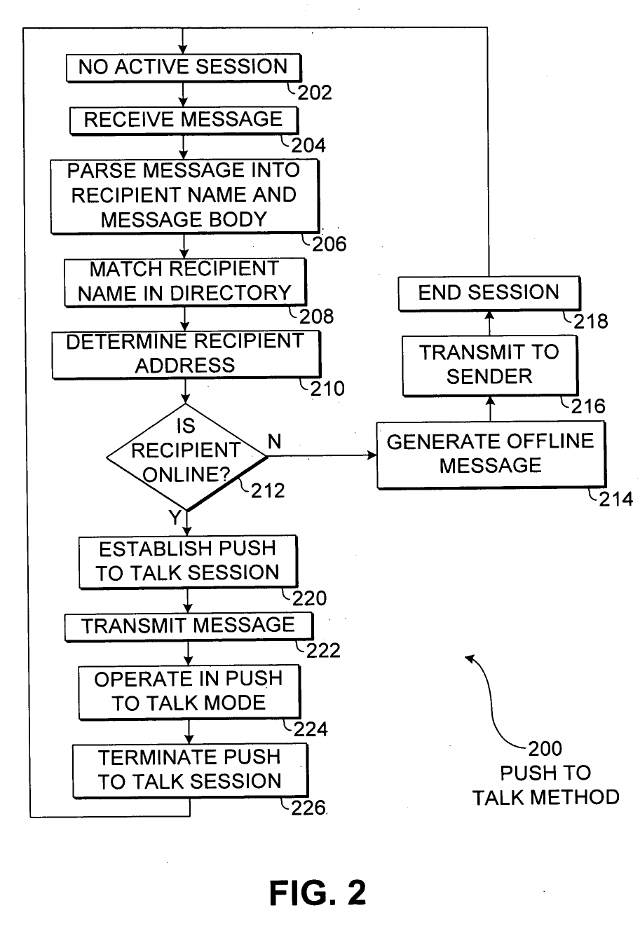

FIG. 2 is a flowchart representation of an embodiment 200 showing a method for push-to-talk communication. There is no active session in block 202. A message is received in block 204 and parsed into a recipient name and message body in block 206. The recipient name is selected from a directory using voice recognition in block 208 and the recipient address is determined in block 210. The recipient's online status is determined from a status database, and if the recipient is not online in block 212, an offline message is generated in block 214, transmitted to the sender in block 216, and the session is terminated in block 218.

If the recipient is online in block 212, a push-to-talk session is established in block 220 and the message is transmitted to the recipient in block 222. The device may operate in a push-to-talk mode with a peer to peer session in block 224 until the session is terminated in block 226.

The embodiment 200 is a method by which a push-to-talk session may be established using an initial message that comprises a recipient name and a message body. The recipient name is parsed from the initial message, an address for the recipient is determined, and, if the recipient is online, a push-to-talk session is established with the message body as the first transmitted message.

The recipient name contained within the first message is in an audio format. In a typical embodiment, this audio snippet may be compared to one or more prerecorded audio snippets that may be stored in a database to determine the appropriate recipient. The same or another database may be used to determine an address for the recipient. In some cases, the address may be a telephone number, IP address, or any other routing designation that may be used by a network to establish communications.

In some embodiments, a keyword may be used between the recipient name and the message body. The voice recognition system may detect the keyword, determine that the portion preceding the keyword may be a recipient name, and use that portion for selecting a recipient from a directory. The keyword may be any spoken word or phrase.

In an alternative embodiment, the recipient online status may not be gathered from a database, but the failure of an attempted session may be used to indicate whether or not a recipient is on line. In such an embodiment, the method may attempt to establish a push-to-talk session as in block 220, transmit a message as in block 222, and if such a transmission failed, the method may proceed with block 214 to generate an offline message. If the session was properly established after block 222, the session would operate as in block 224.

In yet another alternative embodiment, an attempted transmission to a recipient who is offline may cause the message to be stored in the recipient's voice mail storage system. The recipient may retrieve the voice mail message at a later time.

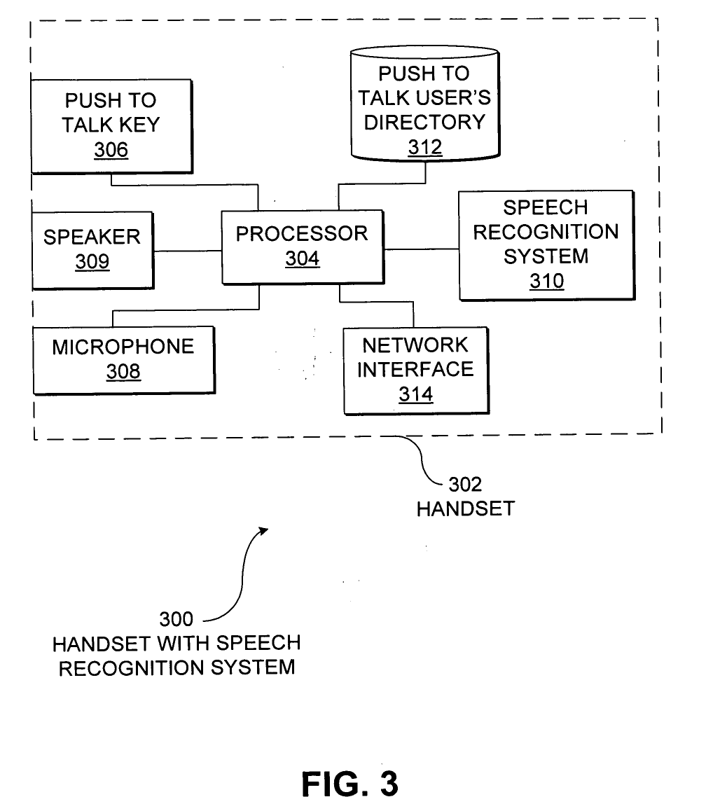

FIG. 3 is a diagrammatic illustration of an embodiment 300 showing a push-to-talk handset having a speech recognition system. The handset 104 has a processor 304 connected to a push-to-talk key 306, a microphone 308, and a speaker 309. The push-to-talk key 306 and microphone 308 may be used in conjunction to receive and record a message. The speaker 309 may be used to play audio messages from other users as well as audio messages generated by the processor 304. The message may be parsed with the speech recognition system 310 and an address for an intended recipient may be determined from a push-to-talk users directory 312. A message may be transmitted through a network interface 314.

The embodiment 300 may be any type of push-to-talk capable device. In many embodiments, the handset 104 may be a hand held wireless transceiver such as a mobile phone, police radio, or any other similar device. In some embodiments, such a handset may fit in the hand, mount on the user's head, or carried in some other fashion. The embodiment 300 may also be a fixed mounted device, such as a desktop phone, personal computer, network appliance, or any other similar device with an audio user interface.

The embodiment 300 may enable the hands free push-to-talk feature to be implemented without changes to the network infrastructure or services. The handset 104, using the speech recognition system 310, may operate as if the user had selected the recipient through using a conventional menu selection and transmitted the information to a push-to-talk server, which would be unaware that the selection was done by voice rather than manual selection.

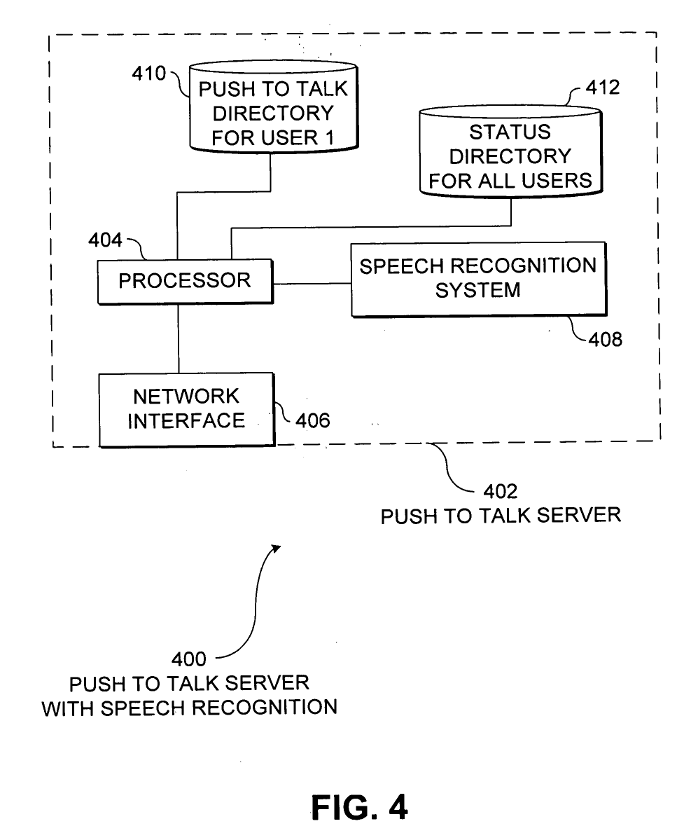

FIG. 4 is a diagrammatic illustration of an embodiment 400 showing a push-to-talk server with speech recognition. The server 116 comprises a processor 404 and a network interface 406. Messages from the network may be processed using a speech recognition system 408 to parse the address component and message component. The address component may be compared to the transmitting user's personal push-to-talk directory 410. Having gathered an address for the recipient from the database 410, the processor 404 may determine the online status of the recipient from the status directory for all users 412. The processor 404 may then transmit the message body to the recipient through the network interface 406.

Those skilled in the art will appreciate that the components described in embodiment 400 may be arranged in many different ways yet still perform essentially similar functions. For example, various actions may be performed by several different processors, and the structure and relationships of the various databases may be different. In many cases, one or more of the databases 410 and 412 may be maintained by one or more other devices connected to the server 402 over a network.

The embodiment 400 illustrates a configuration wherein an initial push-to-talk message is created on a handset and transmitted to the server 116 for parsing. In such an embodiment, the handset may or may not have speech recognition capabilities. Embodiment 400 is one mechanism by which speech recognition capabilities may be deployed on a network system without requiring upgrade or changing of handsets already deployed in the field.

The user's push-to-talk directory 410 may be a subset of a user's full telephone directory, and may contain only the push-to-talk recipients for which the user has previously recorded audio samples of the recipient's name. In some embodiments, the speech recognition system 408 may be capable of comparing an audio sample from an incoming message to prerecorded audio samples. In other embodiments, the speech recognition system 408 may use other methods, such as more complex speech processing methods, for determining if a match exists between the incoming message and the directory 410.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
receiving a push-to-talk audio message from a user, said push-to-talk audio message comprising a recipient name followed by a message body;
parsing said recipient name from said push-to-talk audio message;
matching said recipient name with a recipient name in a recipient database to determine a recipient address; and
attempting to establish a push-to-talk session.

2. The method of claim 1 further comprising:
querying a push-to-talk status database to determine a recipient status for said recipient address.

3. The method of claim 2 further comprising:
determining that said recipient status is online;
establishing a push-to-talk session with a device having said recipient address; and
transmitting said message body to said device.

4. The method of claim 2 further comprising:
determining that said status is offline;
generating an audio response message comprising an indication that said recipient address is offline; and
playing said audio response message.

5. The method of claim 1 further comprising:
detecting a keyword within said push-to-talk audio message.

6. The method of claim 1 wherein said steps of parsing and matching are performed by a mobile handset.

7. The method of claim 1 wherein said steps of parsing and matching are performed by a push-to-talk server.

8. The method of claim 1 further comprising:
failing to establish said push-to-talk session; and
storing at least said message body in a voice mail storage system for said recipient.

9. A handset comprising:
a push-to-talk key;
a directory of a plurality of push-to-talk users;
an interface for connection to a push-to-talk server, said push-to-talk server comprising a database of statuses for each of said push-to-talk users; and
wherein said handset is adapted to:
determine that no push-to-talk session is active between said handset and said push-to-talk server;
parse an initial push-to-talk audio message having a recipient name followed by a message body; and
match said recipient name with one of said push-to-talk users in said directory to determine a recipient device.

10. The handset of claim 9 further adapted to:
determine said status for said recipient device from said push-to-talk server.

11. The handset of claim 10 further adapted to:
based on said status, establish a push-to-talk session with said recipient device; and
transmit said message body to said recipient device.

12. The handset of claim 10 further adapted to:
detect a voice command to end said push-to-talk session; and
close said push-to-talk session.

13. The handset of claim 9 further adapted to:
determine that said status is offline; and
play an audio message indicating that said recipient device is offline.

14. The handset of claim 9 wherein said speech recognition system is further adapted to:
detect a keyword within said initial push-to-talk audio message.

15. A push-to-talk server comprising:
an interface for connecting to a first device, said first device adapted to transmit an initial push-to-talk audio message, said first device having a directory of push-to-talk users;
a processor adapted to:
when no push-to-talk session is active, receive a push-to-talk audio message from a user, said push-to-talk audio message comprising a recipient name followed by a message body;
parse said recipient name from said push-to-talk audio message;
match said recipient name with a recipient name in a recipient database to determine a recipient address; and
attempt to establish a one-to-one push-to-talk session;
a status database;
wherein said push-to-talk server is adapted to determine a status of said one of said push-to-talk users.

16. The push-to-talk server of claim 15 further adapted to:
based on said status, establish a push-to-talk session with said recipient device; and
transmit said message body to said recipient device.

17. The push-to-talk server of claim 16 further adapted to:
detect a voice command to end said push-to-talk session; and
close said push-to-talk session.

18. The push-to-talk server of claim 15 further adapted to:
determine that said status is offline; and
transmit an audio message indicating that said recipient device is offline to said first device.

19. The push-to-talk server of claim 15 wherein said speech recognition system is further adapted to:
detect a keyword within said initial push-to-talk audio message.
